(19) United States
(12) Patent Application Publication
(10) Pub. No.: US 2006/0123359 A1
(43) Pub. Date: Jun. 8, 2006

(54) Portable electronic device having user interactive visual interface

(76) Inventor: Richard J. Schatzberger, Chicago, IL (US)

Correspondence Address: MOTOROLA INC, 600 NORTH US HIGHWAY 45, ROOM AS437, LIBERTYVILLE, IL, 60048-5343, US

(21) Appl. No.: 11/004,337

(22) Filed: Dec. 3, 2004

(51) Int. Cl. G06F 17/00; G06F 3/00; G06F 9/00

(52) U.S. Cl. 715/810; 715/864; 715/835; 715/840; 715/838

(57) ABSTRACT

A portable electronic device, for example, a handheld communication device, including a display (110), a user input interface (150) and a processor (120) coupled to the display and to the user input interface. The processor controls the display and navigation of items arranged in bounded areas of an array in response to inputs at the user interface, wherein each item corresponds to content and/or a feature of the portable electronic device.

### FIELD OF THE DISCLOSURE

The present disclosure relates generally to portable electronic devices, and more particularly to user interactive visual interfaces for portable electronic devices, for example, interactive home and idle screens on cellular communications handset displays and other handheld devices, and methods.

### BACKGROUND OF THE DISCLOSURE

In many electronic devices having small screen displays, information and features from multiple applications are not continuously visible throughout the user experience due to the relatively limited viewing area. This limited visibility limits user interaction with the multiple features and information displayed on the screen. Electronic devices having keypads with a small size or reduced keys also limit user interaction with displayed information.

U.S. Pat. No. 5,774,540 to Davidson et el. discloses a hierarchical menu screen interface for displaying and accessing features on handheld telephone terminals. Davidson et al. provide a user interface having “Next”, “Back”, “Select” and “Home” keys that enable users to navigation menus items. Davidson et al. also provide context sensitive functionality by providing feature choices most likely to be accessed after completion of certain command functions.

The various aspects, features and advantages of the instant disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is a portable electronic device block diagram.

FIG. 2 is an exemplary visual interface schematic.

FIG. 3 is an exemplary visual interface schematic.

FIG. 4 is an exemplary visual interface schematic.

FIG. 5 illustrates neighboring containers.

FIG. 6 illustrates an exemplary containing multiple items.

FIG. 7 is an exemplary home screen including a container among an array of containers.

FIG. 8 illustrates an exemplary array of containers.

### DETAILED DESCRIPTION

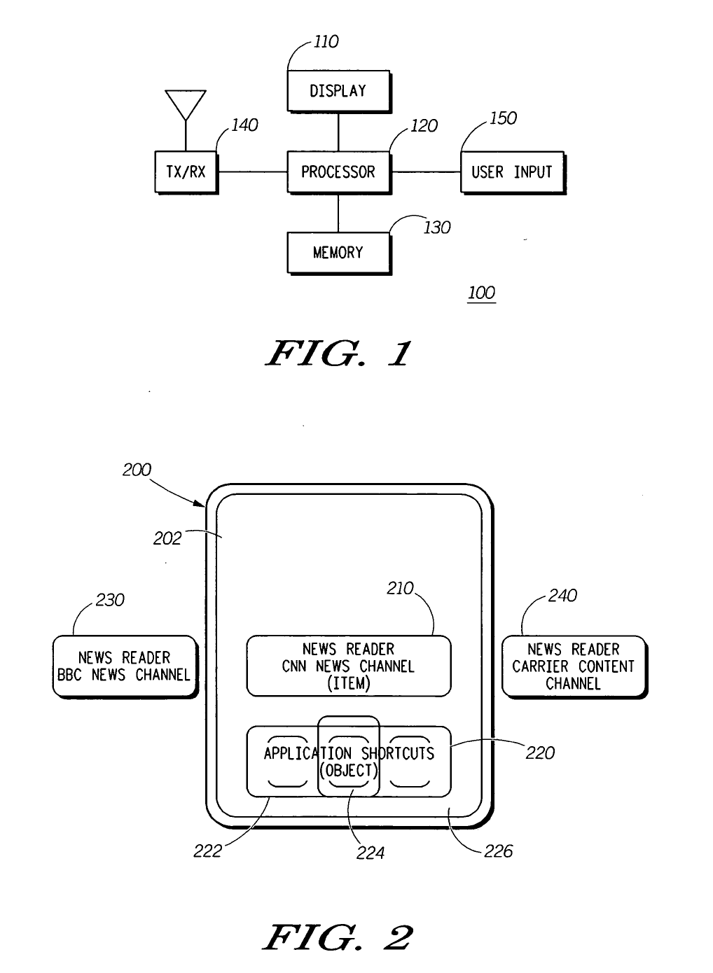

FIG. 1 illustrates an exemplary portable electronic device 100 in the form of a wireless communication handset comprising generally a visual interface 110, for example, a low-power flat panel display or some other display, coupled to a processor 120, which is coupled to memory 130, for example, RAM, ROM, EPROM or another form of memory.

The exemplary wireless communication handset 100 also includes one or more wireless transceivers 140. Exemplary wireless transceivers include cellular transceivers compliant with the GSM, UMTS WCDMA, CDMA 2000 or other cellular communication protocol. The device may also include one or more local area network transceivers, for example, an IEEE 802.xx compliant device, personal space short range transceivers, for example, Bluetooth and/or IRDA compliant devices, among other transceivers. In other embodiments, the device 100 includes a modem, for example, a telephone, broadband, DSL or type of device. In other applications, the portable electronic device is embodied as a personal digital assistant (PDA) or personal organizer, gaming device, laptop or notebook computer, among other devices that may or may not include a wireless transceiver.

While the exemplary embodiments are portable devices, and particularly those having limited display sizes and/or user inputs, the disclosure is also applicable to other devices and applications where the display size is large. An exemplary application of this type is where limited a portion of the total display area is available or dedicated for a particular purpose. The visual interface is integrated with the device, though in other embodiments the visual interface may be a discrete component or device, for example, an accessory.

In FIG. 1, the portable electronic device also includes a user input 150 for receiving user commands for navigating, displaying and selecting or activating information accessible via the visual interface or the limited portion thereof. More generally, the user input also controls other aspects and features of the device that are not necessarily accessible via the display. Exemplary user inputs include keypads, for example, UP/DOWN and LEFT/RIGHT keys, a stylus, a thumb button or joystick, scroll pads, touch screens, among other tactile input devices. Other inputs include audio or voice commands recognition circuitry and/or gesture command sensors, for example, circuitry responsive to movement of the portable electronic device. The instant disclosure is not intended to be limited by any particular input device type, mode or format.

FIG. 2 illustrates an exemplary schematic of a visual interface 200 with a visible display area 202 for viewing the information arranged in bounded areas or containers. Containers are areas on the screen which hold or contain content and/or functionality. The containers also create a boundary that separates and distinguishes neighboring content and functionality. Some containers have content or functional controls displayed in them. Containers can be displayed on the screen as modules. A single visual interface, or display, may accommodate one container or multiple containers, as discussed further below. Thus in some embodiments, all containers are visible at once. In other embodiments, only a limited number of containers are visible at any particular time, wherein additional containers may be made visible by navigation via the user input.

In some embodiments the containers are arranged in an array, some or all of which is displayed on the visible display area 202 at a particular time. The array is a mechanism for organizing items or information representative thereof for navigation and display on the visual interface. The array may have only a single dimension or it may be multi-dimensional, for example, it may have 2 or 3 or more dimensions. In some applications, the array is a virtual array in the sense that all portions of the array may not be displayed on the visual interface at the same time. In some embodiments, for example, only one or two containers are visible at a particular time. The user may generally navigate, display and select items in all containers as discussed further below.

The information in each container generally includes visual information, for example, icons, application shortcuts, links, etc., pertaining to one or more items. In one embodiment, each item corresponds to content and/or a feature, for example, a function, of the portable electronic device. Selection of the corresponding icon, shortcut, link etc. invokes or starts the content or application in the corresponding container. For example, an item or representative visual information may pertain to an application plug-in item, which is launched upon displaying (if the item of representative information is not already displayed) and selecting the item. In another embodiment, an item may be static or streaming content, for example, news, sports, or some other information. The containers in the exemplary embodiments discussed below are approximately the same size, though there is no such requirement. More generally, the containers may have different sizes, for example, containers in a common row or column may be sized differently relative to containers in other rows or columns.

In FIG. 2, multiple containers 210 and 220 are displayed simultaneously in the visible display area 202 for viewing information of the array. The container 210 includes “CNN News Channel” content, and the container 220 includes multiple application shortcuts 222, 224 and 226. Selection of one of the shortcuts prompts or starts a corresponding application. In FIG. 2, the visible display area 202 accommodates information in additional containers along a vertical dimension of the array aligned with container 210, if such additional containers and information exist. Any additional information in containers located above container 210 would be displayed in the visual container area 202. In FIG. 2, the visible container area 202 is substantially the same size as the visual interface 200.

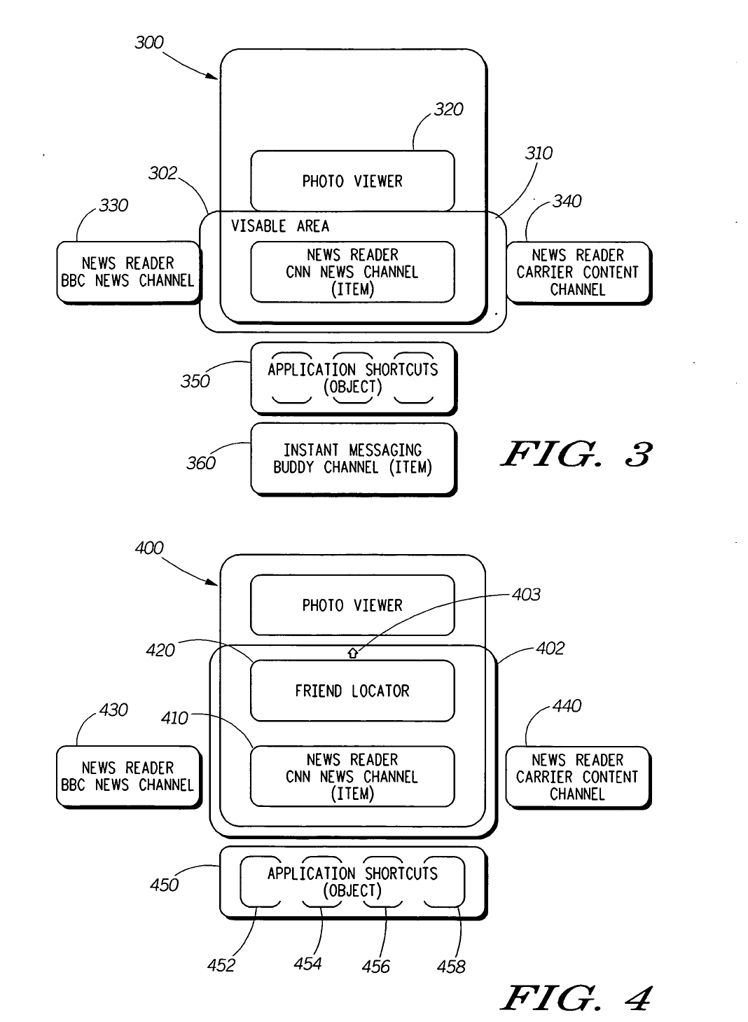

In FIG. 3, the visible area 302 for viewing information of the container array is smaller than the visual interface 300. Thus the visible area 302 accommodates a limited number of containers. Particularly, in FIG. 3, the visible container area 302 is only sufficiently large to accommodate a single container, container 310. Other portions of the display 300 beyond the visible area 302 may be dedicated to displaying other information, which is unrelated to the information of the container array. Thus in FIG. 3, the “Photo Viewer” container 320, which is part of the container array, is not displayed simultaneously on the visual interface although it corresponds in space with the visual interface 300. In some embodiments, the user may select the size of the visible area 302 dedicated to the display of information in the container array. For example, the visible container portion of display 300 may be increased to display more than one container. In FIG. 4, for example, the visible area 402 for viewing the information of the container array accommodates containers 410 and 420.

In FIG. 2, containers 210, 230 and 240 constitute a “News reader” disposed along a common row of the array. Each container includes different news content, for example, container 230 contains “BBC News Channel” content, container 210 contains “CNN News Channel” content, and container 240 contains “Carrier Content Channel” content. In FIG. 3, containers 330, 310 and 340 are configured similarly. In FIG. 4, containers 430, 410 and 440 are also configured similarly. More generally, containers in the same row or column may include unrelated content and/or a mixture of content and applications. In FIG. 3, for example, container 450 contains multiple application item shortcuts, or objects, 452, 464, 456, 458, and container 460 contains a link or shortcut to a “Photo Viewer”.

In one embodiment, information representative of at least one of a plurality of items is displayed on the visual interface, for example, in an array format wherein the information for the plurality of items is disposed in bounded areas arranged in the array. The information in different bounded areas is navigated using a directional user input of the portable electronic device. Manipulating the directional user input may be performed using tactile, audio and gesture inputs, among others as suggested above.

In one embodiment, information in different bounded areas, or containers, along a first dimension the array is navigated by manipulating the directional user input along a first directional axis. In FIG. 3, for example, information in containers 310, 330 and 340 is navigated with vertical manipulation of the directional input. Information in containers 310, 320, 350 and 360 is navigated with vertical manipulation of the directional input. In tactile directional inputs, navigation may be performed by manipulating a directional user input in opposite directions along at least one axis, for example, an axis parallel to the corresponding dimension of the array.

In embodiments where the visible container area does not accommodate all containers of the array simultaneously, the information of the non-displayed containers may be displayed by navigating to the non-displayed container using the directional input. Similarly, where multiple containers are displayed, the focus from one container to another may be changed by navigation. In one embodiment, only one container is focused at a particular time, and the focused container is capable of selection using an input of the portable electronics device. According to this exemplary scheme, unfocused containers may not be selected until or unless selected. Selection of an item includes invoking the corresponding content or functionality thereof, for example, selection of an IP link, starting an application, opening content, etc.

In FIG. 4, containers 410 and 420 are both simultaneously displayed in the visible area 402, but the focus is on container 410. Only the focused container may be selected by the user. The focus may be changed from container 410 to container 420 by manipulating the directional input upwardly or downwardly. Similarly, the focus may be changed from container 410 to container 430 or container 440 by manipulating the user input in the left or rightward directions. Changing the focus from one container to another container may be implemented in one of several ways.

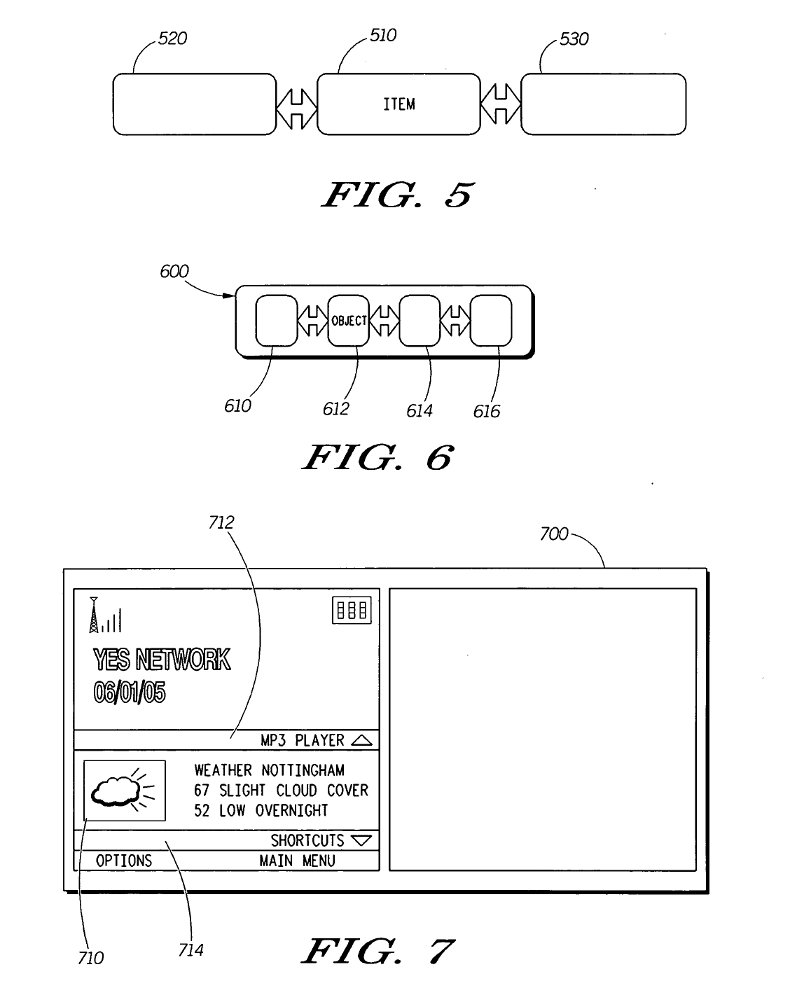

In one embodiment, navigation, for example, vertical or horizontal navigation, causes scrolling of the particular row or column corresponding to the input direction. When scrolling a row or column having non-displayed containers, the non-displayed containers may be displayed by manipulating the direction input in the appropriate direction. In another embodiment, manipulating the directional input in one direction or the other results in the change in location of containers on one side of the focused container without affecting the ordering of containers on the other side of the focused container. In FIG. 5, for example, manipulating the directional input in the leftward direction causes containers 510 and 520 to change positions, such that container 520 becomes the focused container. Manipulating the directional input in the rightward direction causes containers 510 and 530 to change positions, such that container 530 becomes the focused container. In FIG. 3, navigating in the left or right directions will move container 330 or container 340, respectively, into the visible display area 302.

If there are additional containers beyond container 520 and container 530, further manipulation of the directional input will result in the sequential movement of the additional containers into the focused position. For example, all containers to the left of and including container 510 may be scrolled without affecting the containers on the right side of container 510.

In some embodiments, where not all containers are simultaneously displayed on the visible interface, indicia for at least some of the non-displayed containers are displayed near the un-displayed container. In one embodiment, for example, the visual indicator provides indicia for the non-displayed containers immediately adjacent the visible area, thereby informing the user of the existence of neighboring containers. In some embodiments, the indicia provide a general indication of the content of the container. In FIG. 4, arrow 403 indicates that there is another container above container 420. There could also be similar indicators below and on opposite sides of container 410 to indicate the presence of neighboring containers 450, 430 and 440, respectively. Alternatively, the arrow may be replaced by an icon that provides additional information, for example, the icon may indicate whether the un-displayed container contains content or an application, or it may provide more detailed information about the container contents.

In some embodiments, when the user attempts to navigate in a direction, for example, UP or DOWN, in which there are no other un-displayed containers, the navigation action will cause some other event to occur. In one application, navigation in a direction in which there is no additional container results in the launching of an application, for example, a messaging or phonebook application.

In FIG. 2, the container 220 contains a plurality of application shortcuts 222, 224 and 226 that link to corresponding applications or items. Thus some containers include information for multiple items. In FIG. 3, container 350 and container 450 in FIG. 4 also includes multiple items. In one embodiment, when a container containing multiple items is moved into focus, or equivalently when the focus is on a container containing multiple times, the focus is further narrowed to one of the multiple items. Only the focused item may be selected.

In FIG. 2, upon navigating to container 220, the focus is set initially on the centrally located item 224. Alternatively, the initial focus could be on the left or rightmost item, for example, where there is an even number of items in the container. Navigation to change the focus within a container is also performed by manipulation of the directional input. In FIG. 6, for example, container 600 includes items 612, 614, 616 and 618, the focus of which may be changed as discussed above in connection with FIG. 5. Selection of a focused item is performed with the user input of the device.

In one embodiment, navigation along a dimension of the array, for example, a column, changes functionality. This is done by changing the focus of the interaction between containers, functional areas or content (or any item on the screen). This can be done by moving the focus or highlight between the containers or by moving the containers into the area of focus. Horizontal navigation is used to control elements within a container. This can be done to change content or the control. This navigation system allows each container to contain multiple items and options which are either shown whenever the container is visible to the user or displayed when the user navigates to the particular item.

As discussed, in the exemplary embodiment, navigation of the containers is performed using a directional input though more generally some other user input of the portable electronic device may be utilized equivalently. Also, in some embodiments, faster navigation may be achieved between items in a container by performing a command that is specific to the input method. For example, the command could be by pressing and holding a key, or by multiple key depression, etc. As discussed above, selection causes an action to occur. This action is relative to the item on which the select action has been performed. The core usage of this action is to launch an application or perform a task with parameters possessed by the selected item.

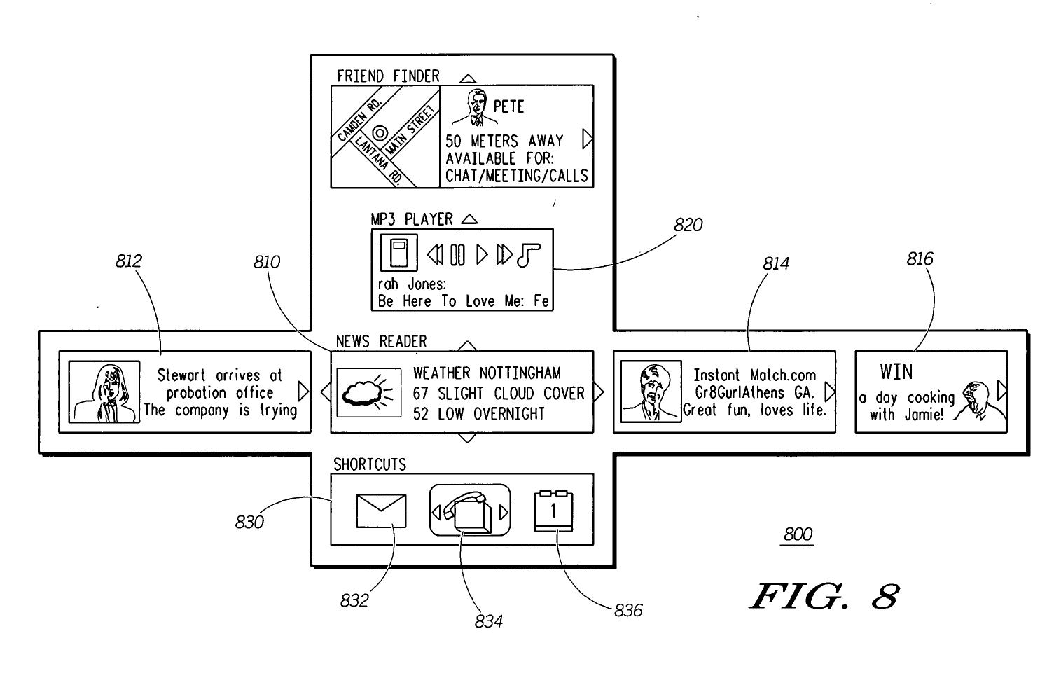

In one embodiment, the array of containers corresponds to the information that is available on the idle, home or default screen of the portable electronic device. FIG. 7 illustrates an exemplary home page on a communication device visual interface 700. A portion 710 of the display is dedicated to displaying containers of a larger container array, most of which is not displayed. FIG. 8 illustrates an exemplary array 800 discussed further below. Other portions of the visual interface may be dedicated to displaying other information unrelated to the container array. In FIG. 7, a single container having weather information is displayed on the interface 700.

The weather container in FIG. 7 corresponds to the weather container portion 810 of the “News Reader” in the container array of FIG. 8. In FIG. 8, the “News Reader” includes other news content in corresponding containers 812, 814 and 816 located in the same row as the weather container 810. In FIG. 7, adjacent to the upper and lower portions of the weather container are portions 712 and 714 indicative of the containers located above and below the weather container. An MP3 player is located above the weather container and short cuts are located below the weather container. In FIG. 8, the container array illustrates the MP3 player container 820 and another container 830 containing multiple application shortcuts 832, 834 and 836. The user navigates the containers as discussed above.

In one embodiment, one or more of the containers of the array is displayed as the default or home display, and the user can navigate to other containers as discussed above. In some embodiments, if there is no activity at a non-home container for a specified time period, the array will automatically display the default container or containers. While the exemplary application of this navigation paradigm is on the idle, home or default screen on a small screen mobile communication device, it can be used throughout the user interface to deliver content or functionality for other sources in an application. This navigation framework can be used on a device with a screen and inputs for interaction, such as a PDA, Television, Computer, Home appliances, among other devices. It allows the same interaction of up, down, left, right and selection actions to occur consistently throughout the user interface and within any application.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a portable electronic device having a visual interface, the method comprising:
displaying information representative of at least one of a plurality of items on the visual interface, the information for the plurality of items disposed in bounded areas arranged in an array, each bounded area associated with information for at least one item;
navigating information in different bounded areas using a directional user input of the portable electronic device;
navigating information within a common bounded area using the directional user input of the portable electronic device.

2. The method of claim 1,
navigating information within the common bounded area includes focusing on different information corresponding to different items in the common bounded area using the directional user input of the portable electronic device.

3. The method of claim 1,
information in at least one bounded area is not displayed when information in another bounded area is displayed,
displaying information in the bounded area not displayed using the directional user input of the portable electronic device.

4. The method of claim 1,
each item corresponding to at least one of content and a feature of the portable electronic device,
navigating information in different bounded areas by manipulating the directional user input along a first directional axis;
navigating information within a common bounded area by manipulating the directional user input along a second directional axis different than the first directional axis.

5. The method of claim 1,
simultaneously displaying information representative of at least two different items on the visual interface,
changing focus from information for one item to information for another item using the directional user input,
an item corresponding to the information focused capable of selection.

6. The method of claim 5, selecting the item for which the corresponding information is focused.

7. The method of claim 1, displaying, on the visual interface, indicium for information not displayed.

8. The method of claim 1,
displaying information not displayed by manipulating the directional user input of the portable electronic device along one of two different directional axes each of which is associated with a corresponding dimension of the array.

9. The method of claim 1, displaying information in at least one bounded area on an idle screen of the visual interface.

10. A method in a portable electronic device having a visual interface, the method comprising:
associating items with a plurality of corresponding containers arranged along dimensions of an array, at least one item associated with each container,
each item corresponding to at least one of content and a feature of the portable electronic device, each container defining a boundary within which visual information pertaining to the at least one associated item is located;
displaying visual information for at least one item on the visual interface;
navigating the visual information by manipulating a directional user input in opposite directions along at least one axis.

11. The method of claim 10,
navigating visual information by manipulating the directional user input in opposite directions along at least two separate axes,
each axis corresponding to a different dimension of the array.

12. The method of claim 10, displaying visual information within another container by navigating to the visual information of the other container.

13. The method of claim 10, displaying visual information for at least one of the plurality of containers on an idle screen of the visual interface.

14. The method of claim 1,
simultaneously displaying visual information for at least two of the plurality of items on the visual interface,
changing focus between the simultaneously displayed visual information by manipulating the directional user input.

15. The method of claim 14, launching the displayed item corresponding to the visual information in focus.

16. The method of claim 10,
displaying, on the visual interface, indicium for visual information that is not displayed.

17. The method of claim 10,
the displayed visual information pertains to an application plug-in item,
launching an application associated with the application plug-in item upon selecting the displayed visual information.

18. A handheld electronic device, comprising:
a display;
a user interface having first and second inputs;
a processor coupled to the display and to the user input interface,
the processor controlling the display and navigation of items arranged in bounded areas of an array in response to inputs at the user interface,
each item corresponding to at least one of content and a feature of the portable electronic device, at least one item associated with each bounded area of the array, at least one item of the array displayed on the display.

19. The handheld electronic device of claim 18,
the first input of the user interface for navigating items in different bounded areas of the array, and the second input of the user interface for navigating items in a common bounded area of the array.

20. The handheld electronic device of claim 18,
one of the first and second inputs of the user interface for focusing on one of a plurality of items simultaneously displayed on the display, the item in focus capable of selection using the user interface.
